(19) United States
(12) Patent Application Publication
(10) Pub. No.: US 2005/0079365 A1
(43) Pub. Date: Apr. 14, 2005

(54) Method for the surface modification of silicone surfaces

(76) Inventors: Christopher W. Widenhouse, Gainesville, FL (US); Eugene P. Goldberg, Mt. Dora, FL (US); Hasseeb Jabbar, Gainesville, FL (US); Daniel Urbaniak, Gainesville, FL (US)

Correspondence Address: MILES & STOCKBRIDGE PC, 1751 PINNACLE DRIVE, SUITE 500, MCLEAN, VA, 22102-3833, US

(21) Appl. No.: 10/820,139

(22) Filed: Apr. 8, 2004

(30) Foreign Application Priority Data
Oct. 9, 2002 (WO) PCT/US02/32050

(51) Int. Cl. B05D 3/00; B32B 9/04

(52) U.S. Cl. 428/447; 427/551; 427/487

(57) ABSTRACT

Disclosed is a method for modifying the surface properties of a silicone or siloxane-based polymer or copolymer substrate comprising, (1) exposing the surface to a basic aqueous resolution comprising a substance capable of graft-polymerization with the silicone or siloxane-based polymer or copolymer substrate, the aqueous solution having a pH above about 8.0, the exposure to the basic aqueous solution being for a time sufficient to enhance the graft-polymerization and (2) subjecting the surface and basic solution to conditions whereby the polymerizable substance is polymerized to form a graft-polymerized coating on the surface. Also disclosed are compositions of matter prepared by the above-described process as well as articles manufactured therefrom.

### BACKGROUND OF THE INVENTION

1. Field of the Invention

The present invention relates to a method for modifying the surfaces of materials to impart desired characteristics thereto.

2. Description of the Prior Art

In selecting materials for constructing articles, the artisan is often faced with a perplexing dilemma. A specific material may meet most of the requirements of the proposed application, such as strength, weight, density, structure, machinability, electromagnetic properties, etc.; however, its surface characteristics may render it unsuitable for that particular use. For example, studies have shown that the surgical implantation of ocular implants such as intraocular lenses (IOLs), etc., results in the loss of significant corneal endothelial tissue unless great care is taken to ensure a lack of contact between the device and the endothelium. Most ocular implants are constructed of hydrophobic polymethyl methacrylate (PMMA) polymers because of their superior optical qualities, resistance to biodegradation, etc. It has been found, however, that PMMA surfaces adhere to endothelial cells upon even casual contact and that separation of the surface therefrom results in a tearing away of the endothelial tissue adhered to the polymer surface. Similar adhesive interactions with other ocular tissues, i.e., the iris, can also cause adverse tissue damage. Other hydrophobic polymers which are used or have been proposed for use in ocular implants (i.e., polypropylene, polyvinylidene fluoride, polycarbonate, polysiloxane) also can adhere to ocular tissue and thereby promote tissue damage.

It is well documented in the prior art that a significant disadvantage inherent in PMMA IOLs resides in the potential for long-term abrasive interactions with sensitive tissues such as the iris, ciliary sulcus, etc., and that even brief contact between the corneal endothelium and hydrophobic polymer surfaces, i.e., PMMA, can result in extensive damage to the endothelium. See Katz et al, Trans. Am. Acad. Ophth., Vol. 83, p. 204-212 (1977).

Since it is extremely difficult to avoid any contact between implant surfaces and sensitive tissue surfaces such as ocular tissue during surgical procedures, efforts have been undertaken in ocular surgery to modify ocular implant surfaces, i.e., PMMA, to reduce the tendency thereof to adhere to and damage the corneal endothelium.

Ocular implant surfaces have been coated with various hydrophilic polymer solutions or temporary soluble coatings such as methylcellulose, polyvinylpyrrolidone, etc., to reduce the degree of adhesion between the implant surfaces and endothelial tissue cells. While offering some temporary protection, these methods have not proven entirely satisfactory, since such coatings complicate surgery, do not adhere adequately to the implant surfaces, become dislodged or deteriorate after implantation, dissolve away rapidly during or soon after surgery, or may produce adverse post-operative complications. Moreover, it is difficult to control the thicknesses and uniformity of such coatings.

Various surface modification techniques have already been proposed, and some of them are in use. For instance, surface grafting of hydrophilic monomers onto hydrophobic polymers has been achieved by photo-induced >Oster et al, J. Polym. Sci., Vol. 26, p. 233 (1957); Oster et al, Ibid., Vol. 34, p. 67 (1959); Tazuke et al, J. Polym. Sci., Polym. Lett. Edn. 16, p. 497 (1978); and Ogiwara et al, J. A ppl. Polym. Sci., Vol. 23, p. 2397 (1979) and radiation-induced polymerization Jansen et al, J. Biomed. Mater. Res., Vol. 19, p. 1085 (1985); Boffa et al, J. Biomed. Mater. Res., Vol. 11, p. 317 (1977). However, all these methods suffer major limitations, i.e., grafting reactions are not confined to the outer substrate surface layers; grafting reaction time is too long; the coatings obtained are generally only physically absorbed on the substrate surface; and, finally, because of the relatively high penetration power of the radiation required for grafting, permanent chemical and structural changes such as cross-linking and degradation are commonly encountered. [Mukherjee et al, J. Macromol. Sci.-Rev. Macromol. Chem. Phys., Vol. C26(3), p. 475 (1986)].

In addition to polymeric ocular implants, there are also a wide variety of metallic, ceramic and polymeric medical instruments, devices and implants which could be beneficially surface modified to yield non-adherent, tissue-protective and more blood-compatible hydrophilic polymer grafted surfaces. Improved methods and materials for hydrophilic polymer surface modification of various polymeric instruments, devices, etc., have been set forth, U.S. Pat. No. 5,100,689. However, certain polymer substrates, i.e., fluorocarbon polymers, and especially metal and ceramic substrates, are extremely resistant to effective grafting of uniform, highly adherent surface modifications by the major methods available, i.e., gamma radiation polymerization grafting and glow discharge plasma polymerization.

Glow discharge plasma (GDP) has been extensively studied for surface modification of biomedical polymers. [Yasuda, in Plasma Polymerization, Academic Press, Inc. (1985); Kim et al, CRC Crit. Rev. in Biocomp., Vol. 1, p. 229 (1985); Ratner et al, in Trans. 2nd World Cong. Biomaterials, Washington, D.C. (1984)]. GDP may be achieved most commonly by radiofrequency induction, or by DC discharge or microwave methods and has been used in two primary ways: 1) surface etching and/or oxidation by plasma treatment, and 2) plasma thin film polymerization and deposition. GDP induced by an inductively coupled radio frequency current (RF-GDP) is a high-energy state of ionized gases formed by passing gas or vapor molecules through a high-energy field. The resulting activated species possess sufficient energy to chemically alter the surface of a substrate placed in the GDP by generating activated surface species such as radicals or ion radicals. When exposed to air, these radicals or other activated sites can also combine with oxygen to form sites for further chemical reaction and polymerization with various vinyl monomers. Furthermore, monomers present in the plasma may be activated and graft polymerized to activated sites on the substrate. Under GDP conditions, even relatively unreactive compounds such as benzene, toluene, perfluoro propane, etc., which are not vinyl monomers may also be sufficiently activated to enable polymer-forming reactions.

Observations indicate that when hydrophobic polymers, such as FEP (Teflon), PC (polycarbonate), PMMA (poly-methylmethacrylate), PDMSO (polydimethylsiloxane), PP (poly-propylene), etc., are placed in a plasma even at relatively low power and for short exposure times and contact traces of oxygen, they become more hydrophilic due to surface oxidation. It has also been demonstrated that many polymers can be reduced or oxidized depending upon GDP conditions, thus altering their surface properties. [Clark et al, J. Polym. Sci., Polym. Chem. Edn. 21, p. 837 (1983)].

Plasma treatment can cause chain scission, ablation, cross-linking, oxidation and other reactions to a depth of 50-100ANG or more depending on the substrate and experimental conditions [Wu et al, in Polymer Interphase and Adhesion, Chap. 9, p. 298, Marcel Dekker, New York (1982)].

The case of gamma polymerization alone has also been extensively studied for surface grafting of hydrophobic polymers [Boffa, supra; Hegazy et al, J. Appl. Polym. Sci., Vol. 26, p. 3117 (1981); Mukherjee et al, J. Appl. Polym. Sci., Vol. 30, p. 2643 (1985); Hoffman et al, Arch Phys. Chem., Vol. 22, p. 362 (1983)]; yet this method, by itself, is not always satisfactory. In addition to the problems mentioned earlier, gamma irradiation of substrate and monomer causes solution polymerization as well as grafting onto the substrate. Grafting is dependent on the prevalence of excited surface species such as radicals generated by gamma radiation, which in turn is dependent upon the energy required to form such activated species in a particular substrate. Therefore, substrates with high activation energies for radical formation relative to monomer solutions do not easily graft by gamma polymerization before extensive solution polymerization and gelation occurs, making sample removal and washing impractical.

The hydrophilic surface modification of siloxane based polymers is especially difficult because of the extraordinary flexibility and mobility of the polysiloxane molecular change (for example polydimethylsiloxane). To impart hydrophilic characteristics or increased wetting of the surfaces is a difficult problem often requiring methods such as radio frequency plasma techniques or a combination of several different steps. Even so, the prior art results have not been generally successful or practical.

Gamma radiation initiated polymerization of NVP and other monomers onto various substrates has been taught in the literature for a number of years. It has been found to be extremely difficult, however, to modify siloxane based polymers and copolymers using the techniques taught in this art without some pre-step, such as “presoaking” the substrate in monomer or by “pre-treating” the substrate with RF plasma or other methods.

The surface modification of siloxane based polymers by a method which includes the hydrolysis of the surface with acidic or basic compounds to tailor the binding capacity for ions, particularly metal ions, bivalent cations, organic macro anions, and organic macro cations, e.g. proteins. has also been taught in the literature. This recent method involves first subjecting the substrate polymer to hydrolysis and then by exposing it to an ionic compound that will bond to the charges created by the hydrolysis. This method is a two step process, and only involves charged particles or compounds, and does not involve the polymerization onto the silicone surface of a surface polymer. [U.S. Pat. No. 5,494,756, Feb. 27, 1996] Other prior art references in this area include Goldberg, et al, “Ocular implants and methods for their manufacture” (U.S. Pat. No. 4,806,382, Feb. 21, 1989); Goldberg, et al, “Surface modified surgical instruments, devices, implants, contact lenses and the like” (U.S. Pat. No. 4,961,954, Oct. 9, 1990); Goldberg “Surface modified surgical instruments, medical devices, implants, contact lenses and the like” (U.S. Pat. No. 5,885,566, Mar. 23, 1999); Isenberg, et al, “Povidone-iodine neonatal ophthalmic antimicrobial prophylactic agent” (U.S. Pat. No. 5,232,692, Aug. 3, 1993), and Darouiche, et al, “Antimicrobial impregnated catheters and other medical implants” (U.S. Pat. No. 5,902,283, May 11, 1999).[The entire disclosures and contents of all U. S. patents referred to herein are incorporated herein by reference]

### SUMMARY OF THE INVENTION

An embodiment of the invention relates to a method for modifying the surface properties of a silicone or siloxane-based polymer or copolymer substrate comprising, (1) exposing the surface to a basic aqueous solution comprising a substance capable of graft-polymerization with the silicone or siloxane-based polymer or copolymer substrate, the aqueous solution having a pH above about 8.0, the exposure to the basic aqueous solution being for a time sufficient to enhance the graft-polymerization and (2) subjecting the surface and basic solution to conditions whereby the polymerizable substance is polymerized to form a graft-polymerized coating on the surface.

Another embodiment of the invention concerns the composition formed by the above-described method.

Still further embodiments of the invention are articles manufactured from the above-described compositions.

### DETAILED DESCRIPTION OF THE INVENTION

The present invention is predicated on the discovery that the graft-polymerization of a polymerizable substance to form a coating on the surface of a silicone or siloxane-based polymer and/or copolymer is greatly enhanced by the prior or simultaneous exposure of the surface to a basic aqueous solution having a pH above about 8.0. While not wishing to be bound by any theory of the mechanism of the method of the invention, siloxane-based polymers are subject to hydrolysis under basis conditions, i.e., pHs above about 8.0, and, the higher the pH, typically, the greater the degree of hydrolysis. It is theorized, therefore, that this hydrophilic propensity may, to some degree, be a contributing factor in the enhancement of the graft polymerization process.

The preferred agent for adjusting the pH of the aqueous solution is a metal hydroxide, more preferably alkali earth metal hydroxides, most preferably alkali metal hydroxides; the optimum agent comprising sodium or potassium hydroxide. In the presence of the polymerizable substance, such as e.g., N-vinylpyrrolidone (NVP), and being subjected to polymerizing conditions, such as, e.g., radiation from a gamma radiation source, surface graft polymerization of the NVP is greatly facilitated by the basic medium. Surface polymerization of the NVP, for example, thereby produces a more stable and lower contact angle, i.e., a more wettable surface, on silicones than is obtained by similarly conducted polymerizations at normal, near pHs of 6.0-8.0.

### EXAMPLE 1

Small disks were punched from a sheet of polydimethylsiloxane (PDMS) and washed in isopropyl alcohol to remove residual contaminants from handling and punching. The samples were dried in an oven at 80-110° C. for at least 2 hours. The samples were then placed into a solution comprising water, sodium hydroxide (NaOH), and N-vinylpyrrolidone (NVP) monomer. Four NaOH concentrations were evaluated, 0.5%, 1%, 1.5% and 2.0%; all having a pH >8.0 up to about 13.0

Solutions of NaOH in water were made at concentrations of 0.5, 1.0, 1.5, and 2.0% by weight (i.e., the 1.0% solution contained 1 gram of NaOH in 100 grams of water) and then used to make a 10% NVP solution by weight (i.e., 10 grams of NVP was added to 90 grams of a salt solution).

This solution is then subjected to a vacuum degassing in order to remove as much dissolved oxygen and air from the solution as possible. A vacuum was applied to the container containing the solution, and the solution was allowed to ‘boil’ and degas for approximately 5 minutes. Oxygen/air degassing may also be accomplished by bubbling argon through the solution for several minutes. The solution was then added to glass vials which contained the silicone disk samples. The vials were closed with a plastic lid and placed into a cobalt-60 irradiator. The samples were exposed to gamma radiation at a dose rate of approximately 575 rads/min for a total exposed dose of approximately 0.13 Mrads.

The vials were removed from the irradiator, and the solution surrounding the samples was removed. The samples were then continuously washed in water with fresh water changes periodically until there were no traces of monomer or polymer remaining in the solution as measured with UV/Vis spectroscopy.

The samples were then analyzed and characterized with respect to wettability by surface contact angle, graft thickness, and surface chemistry as measured using XPS.

All samples were found to have a contact angle less than 30° that indicated the sample had been surface modified with a hydrophilic monomer as shown by a reduction in the air bubble in water contact angle using captive bubble goniometry.

To identify the depth of penetration of the graft, i.e., graft thickness, the modified samples were soaked in two separate solutions. Samples were soaked in either a saturated aqueous iodine solution for 12 hours or an aqueous 8% silver nitrate solution for 12 hours. The samples soaked in iodine were then rinsed in water for 12 hours and dried. The samples soaked in silver nitrate were immersed in a phosphate buffered formalin solution which caused the precipitation of silver chloride, silver oxide, and silver phosphate. Both of these methods cause a coloration or staining of the grafted region because the iodine or silver nitrate solutions primarily penetrate the substrate surface to the extent that has been rendered hydrophilic by the surface modification. These samples were then cross sectioned and examined by optical microscopy. All samples showed a surface graft. For example, using a 2% NaOH solution of monomer, the stained graft layer was approximately 7-10 μm. A silicone sample that was not surface modified by the above-described method but was subjected to the staining procedure showed no evidence of surface modification as indicated by the lack of a brownish surface layer.

### EXAMPLE 2

Small disks were punched from a sheet of polydimethylsiloxane (PDMS) and washed in isopropyl alcohol to remove residual contaminants from handling and punching. The samples were dried in an oven at 80-110° C. for at least 2 hours. The samples were then placed into a solution comprising water, sodium hydroxide (NaOH) and N-vinylpyrrolidone (NVP) monomer. An NaOH A concentration of 2% was used, and varying amounts of alcohols were added to the solutions.

First, aqueous alcohol solutions were made using methanol or isopropanol in water at concentrations of 0.5, 25, 50, 75, and 95% by weight (i.e., the 25% isopropanol solution contained 25 grams of isopropanol and 75 grams of water). These solutions were then used to make a 10% NVP solution by weight (i.e., 10 grams of NVP was added to 90 grams of a salt solution). For example, 25% isopranol in water consisted of 25 grams isopropanol and 75 grams of water; 25% methanol in water consisted of 25 grams methanol and 75 grams of water.

The alcoholic solutions were then used to make 2% solutions of NaOH, KOH, NaCl, and KCl. To make these solutions, 2 grams of each salt was added to 100 grams of each of the above solutions.

Each of these alcoholic salt solutions was then used to make an approximately 10% solution with NVP by adding 10 grams of NVP monomer to 100 grams of each of the alcoholic salt solutions.

Each of these solutions was then degassed as in Example I in order to remove as much dissolved oxygen and air from the solution as possible. The solutions were then added to glass vials which contained the silicone disk samples. The vials were closed with a plastic lid and placed into a cobalt-60 irradiator and exposed to gamma radiation as in Example 1.

The vials were removed from the irradiator, and the solution surrounding the samples was removed. The samples were then continuously washed in water with fresh water changes periodically until there were no traces of monomer or polymer remaining in the solution as measured with UV/Vis spectroscopy.

The samples were washed and analyzed as in example 1. All samples showed contact angles <35° and surface graft by staining.

To identify the depth of penetration of the graft, the modified samples were soaked in two separate solutions. Samples were soaked in either a saturated aqueous iodine solution for 12 hours or an aqueous 8% silver nitrate solution for 12 hours. The samples soaked in iodine were then rinsed in water for 12 hours and dried. The samples soaked in silver nitrate were immersed in a phosphate buffered formalin solution which caused the precipitation of silver chloride, silver oxide, and silver phosphate. Both of these methods cause a coloration or staining of the grafted region because the iodine or silver nitrate solutions can only penetrate the substrate surface to the extent that it has been rendered hydrophilic by the surface modification. These samples were then cross-sectioned and evaluated using optical microscopy. All samples showed a depth of penetration of the surface graft by staining.

### EXAMPLE 3

Small disks were punched from a sheet of polydimethylsiloxane (PDMS) and tumble-washed with nanopure water to remove residual contaminants from handling and punching. The samples were dried in a vacuum oven at 65° C. for 2 hours. The samples were then placed in a solution comprising water, sodium hydroxide (NaOH) base, and N-vinylpyrrolidone (NVP) monomer. Four base concentrations were evaluated, 0.5%, 1.0%, 1.5% and 2.0%.

A solution of NaOH in water was made at a concentration of 0.5%. The solution was then used to make a 10% NVP solution by volume (i.e., 10 ml of NVP was added to 90 ml of base solution.

The 10% NVP/90% base solution was then added to glass vials containing one silicone disk each. The vials were subjected to vacuum to remove as much dissolved oxygen and air from the solution and submerged disk as possible. A vacuum was applied to the vials containing the solution and disks and allowed to “boil” and degas for approximately 2 minutes. The vials were backfilled with argon gas, sealed with plastic lids and placed in a cobalt-60 irradiator. The samples were exposed to gamma radiation at a dose rate of approximately 600 rads/minute for 80 minutes for a total exposed does of approximately 0.05 Mrads.

The vials were removed from the irradiator, and the solutions surrounding the samples were removed. The samples were then continuously washed in ultrapure water with fresh water changes periodically.

The samples were then analyzed and characterized with respect to surface contact angle using captive air bubble goniometry. The average contact angle measured was 23° for the disks irradiated in grafted solutions using 0.5% NaOH silicone disks that were not treated had an average contact angle of 83%.

Following the initial contact angle measurements, the samples were dried in a vacuum oven at room temperature for 12 hours and rehydrated and remeasured for contact angle. The average contact angles measured were 27° for the rehydrated disks irradiated in grafting solutions using 0.5% NaOH.

The samples were dehydrated and rehydrated for several days and remeasured for contact angle again. The average contact angles measured were 28° for the disks irradiated in grafting solutions using 0.5% NaOH.

These experiments indicated that the modification to the silicone surface was highly hydrophilic and stable under various storage conditions for an extended amount of time following irradiation. Silicone modified at hear neutral pH (6.0-8.0) without addition of NaOH gave higher initial contact angles (>35°) and upon dehydration and rehydration the contact angles increased to about 50° implicating less stability and less hydrophilicity.

In carrying out the method of the invention, graft polymerization may be induced by gamma or electron beam radiation initiation, ultraviolet (IV) radiation initiation, chemical initiation, electrochemical initiation, or any other conventional graft polymerization method. Gamma and electron beam irradiation are the preferred modes of graft polymerization. In general, the total gamma or electron beam dose is in the range of from about 0.001 to about 0.5 Mrads, the gamma dose is in the range from about 10 to about 2500 rad/min, and the electron beam dose rate is from about 10 to about 108 rads/min.

The invention-is applicable to virtually any polysiloxane, or copolymer thereof with polyesters, polyolefins, polyurethanes, polyimides, polyamides, polysulfones, polysulfides, polyacrylates, polyacrylics, polystyrenes, polymethacrylates, ethylene-propylene copolymers, polybutadiene, styrenebutadiene copolymers, styrene-ethylene-butadiene copolymers, polycarbonates, fluorocarbon polymers, polyurethanes, polyvinylchloride, or mixtures thereof, as well as ceramics, metals, or composites wherein the above polymers and/or copolymers are utilized in the construction thereof.

Exemplary of suitable monomers or oligomers are
a) N-vinylpyrrolidone NVP, or
b) 2-hydroxyethylmethacrylate (HEMA), or
c) an alkali metal, e.g., the sodium or potassium salt of sulfopropyl acrylate (NaSPA or KSPA), or
d) a vinylsulfonic acid such as sulfoethylmethacrylate, sulfopropylmethacrylate, styrene sulfonic acid, 2-acrylamide-2-methyl-1-propane sulfonic acid, or vinylsulfonic acid, including mixtures and salts thereof, or
e) an amino-functional monomer such as vinylpyridine, an aminostyrene, an aminoacrylate or an aminomethacrylate, including mixtures and salts thereof, or
f) acrylamide, dimethylacrylamide, polyethylene glycol monomethacrylate, hydroxypropylacrylamide, methacrylic acid, dimethylaminoethylmethacrylate, including mixtures and salts thereof.

It will be understood by those skilled in the art that mixtures of the various monomers and/or oligomers may also be employed in the practice of the invention. Those skilled in the art will also appreciate that the reaction parameters disclosed herein will require some experimentation that does rise to the level of invention to determine the optimum conditions for each particular substrate or monomer/oligomer utilized.

The monomer is preferably employed in a concentration in the range from about 0.01% to about 50%, by weight.

NaOH, KOH, Ca(OH)₂, LiOH, and the like may be employed to form the basic hydrolyzing solution. Organic bases that increase the pH of aqueous solutions may also be used and include, for example, amines and aminoalcohols such as triethylamine, ethanolamine and the like. Salts which form ionic solutions in aqueous media such as NaCl, KCl, CaCl₂, LiCl, Kl, Nal, etc, may also be used in conjunction with the base agents.

Optimally, the method can further include pre-soaking the article surface in at least one of the monomers in a solution of from about 5% to about 95% by weight prior to conducting the polymerization for a period of time and at a temperature sufficient to facilitate diffusion of the monomer or monomers into the article surface. Thus, the pre-soaking step may be conducted at a temperature in the range of from about 250 to about 90° C. and for a period of time of from about 0.25 to about 48 hours.

The method of the invention is extremely useful for imparting new surface properties to siloxane-based polymers. Siloxane based polymers are utilized for particular applications because they have specific electrical properties, specific properties of stretch, bend, and flexibility, and for the ease with which they can be manufactured into virtually any shape or final product desired. However, the specific properties of the surface layer of siloxane polymers and copolymers are sometimes different than the desired properties. Rather than try to develop an entirely new material to replace the siloxane, it is often desired to just change the surface of the material by either adhering a polymer with the desired properties to the surface, or by chemically modifying the surface to have the desired properties.

More specifically, in instances where biomedical devices and biomaterials, i.e., materials and devices used in medicine, surgery, and healthcare-are constructed of siloxane polymers and copolymers, it is desired that the surface properties thereof be more hydrophilic. Siloxane polymers are, by nature, hydrophobic, that is, they repel water. These devices typically will have better compatibility with human body tissues if they are hydrophilic or more water compatible. The process of the present invention can be applied to very intricate shapes, designs, and complete medical devices, without damaging any of the properties that make siloxane based polymers the initial choice for the application.

An additional advantage of the process of the invention is that the surface, after it has been modified, can be loaded with drugs for a variety of purposes, e.g., the incorporation of a compound that will make the devices resistant to bacterial growth and infection.

Examples of devices which are susceptible to modification according to the process of the invention include:

| | |
|---|---|
| Intraocular lenses | |
| Catheters | Pacer leads |
| Surgical Tubing | Endotracheal tubes |
| Blood Bags | Peripheral nerve grafts |
| Contact lenses | Dialysis shunts |
| Breast Implants | Numerous soft tissue implants for plastic surgery |
| Myringotomy tubing | Secondary components of various medical devices |
| | and equipment |
| Glaucoma Shunts | Surface interface devices for neural connections |
| Hernia repair | Bio-DNA chips and microfluidics research areas |
| membranes | (Silicon wafers have been the primary substrate of |
| | choice for these applications, until recently, when |
| | the majority of the research has switched to silicone |
| | polymer based systems). |

The present invention provides, for the first time, a simplified process for the surface modification of siloxane based polymers and copolymers. Additionally, it offers the ability to surface modify other polymers and materials with a simple one step process. It offers manufacturers of siloxane-based devices the opportunity to impart surface modifications to improve the properties of specific devices in an easy and cost efficient manner.

The surface properties of these devices are enhanced, however, when made hydrophilic to facilitate the long term success of these devices. The present invention provides the art with the ability to impart hydrophilic and surface modified characteristics to the surface of these devices without altering the processing steps necessary to achieve the final form and function of the device.

An additional advantage of this system is the ability to incorporate drugs, biological molecules, pharmaceutical compounds, antibacterial agents and the like into the surface modification either during the process or after the process. With respect to medical devices, the present invention offers the ability to surface modify a final device and impart improved surface characteristics to the device as well as potentially render it resistant to infection by, e.g., incorporating therein an antibiotic. Additionally, other drugs may be loaded into the surface that allows the treatment of disease processes which necessitated the implantation of the device initially. Virtually any therapeutically, prophylactically or diagnostically effective amount of a biologically active agent that is compatible with the silicone substrate and the polymer coating grafted thereto may be employed in the practice of the invention. Suitable examples thereof include proteins, muteins and active fragments thereof, such as immunoglobulins, antibodies, cytokines (e.g., lymphokines, monokines, chemokines), interleukins, interferons (.beta.-IFN, .alpha.-IFN and .gamma.-IFN), erythropoietin, nucleases, tumor necrosis factor, colony stimulating factors, insulin, enzymes (e.g. superoxide dismutase, tissue plasminogen activator), tumor suppressors, blood proteins, hormones and hormone analogs (e.g., growth hormone, adrenocorticotropic hormone and luteinizing hormone releasing hormone (LHRH)), vaccines (e.g., tumoral, bacterial and viral antigens), antigens, blood coagulation factors; growth factors; peptides such as protein inhibitors, protein antagonists, and protein agonists; nucleic acids, such as antisense molecules; oligonucleotides; and ribozymes. Small molecular weight agents suitable for use in the invention include, antitumor agents such as bleomycin hydrochloride, carboplatin, methotrexate and adriamycin; antibiotics such as gentamicin, tetracycline hydrochloride and ampicillin; antipyretic, analgesic and anti-inflammatory agents; antitussives and expectorants such as ephedrine hydrochloride, methylephedrine hydrochloride, noscapine hydrochloride and codeine phosphate; sedatives such as chlorpromazine hydrochloride, prochlorperazine hydrochloride and atropine sulfate; muscle relaxants such as tubocurarine chloride; antiepileptics such as sodium phenytoin and ethosuximide; antiulcer agents such as metoclopramide; antidepressants such as clomipramine; antiallergic agents such as diphenhydramine; cardiotonics such as theophillol; antiarrhythmic agents such as propranolol hydrochloride; vasodilators such as diltiazem hydrochloride and bamethan sulfate; hypotensive diuretics such as pentolinium and ecarazine hydrochloride; antidiuretic agents such as metformin; anticoagulants such as sodium citrate and sodium heparin; hemostatic agents such as thrombin, menadione sodium bisulfite and acetomenaphthone; antituberculous agents such as isoniazide and ethanbutol; hormones such as prednisolone sodium phosphate and methimazole; antipsychotic agents such as risperidone; and narcotic antagonists such as nalorphine hydrochloride, and the like.

1. A method for modifying the surface properties of a silicone or siloxane-based polymer or copolymer substrate comprising exposing said surface to (1) an aqueous solution comprising said agent and having a Ph above or below 7.0 and (2) gamma radiation, said exposure taking place at a pH, gamma dose, temperature and for a time sufficient to hydrolyze said surface so as to a) form thereon functional groups reactive with said agent and b) induce polymerization of said agent, thereby forming a graft-polymerized coating on said surface.

2. The method of claim 1 wherein said polymerizable agent is a monomer, oligomer or mixture thereof, the graft polymerization of which with the surface forms a coating more hydrophilic than the uncoated surface.

3. The method of claim 2 wherein said substance is N-vinylpyrrolidone, 2-hydroxyethylmethacrylate, an alkali salt of sulfopropyl acrylate, a vinylsulfonic acid an amino functional monomer, oligomer or mixture thereof, acrylamide, dimethylacrylamide, polyethylene glycol monomethacrylate, hydroxypropylacrylamide, methacrylic acid or dimethylaminoethylmethacrylate.

4. The method of claim 1 wherein said substrate comprises polydimethylsiloxane, or a copolymer of a siloxane with a polyester, polyolefin, polyurethane, polyimide, polyamide, polysulfone, pulysulfide, polyacrylate, polyacrylic, polystyrene, polymethacrylate, ethylene-propylene copolymer, polybutadiene, styrene-butadiene copolymer, styrene-ethylene-butadiene copolymer, polycarbonate, fluorocarbon polymer, polyvinylchloride, or mixtures thereof.

5. The method of claim 1 wherein said solution contains a metal hydroxide to achieve said pH.

6. The method of claim 5 wherein said metal hydroxide is an alkali earth metal hydroxides or an alkali metal hydroxides.

7. The method of claim 5 wherein said metal hydroxide is a sodium or potassium hydroxide.

8. The method of claim 1 wherein the concentration of said substance in said solution is from about 0.01% to about 50%, by weight.

9. The method of claim 1 including the step of pre-soaking said substrate surface in a solution of from about 5% to about 95% by weight, of said agent prior to polymerization for a period of time and at a temperature sufficient to facilitate diffusion of at least a portion of said agent into said substrate surface.

10. The method of claim 1 wherein said graft-polymerization conditions comprise gamma or electron beam irradiation.

11. The method of claim 1 wherein the total gamma or electron beam dose is in the range of from about 0.001 to about 0.5 Mrads, the gamma dose rate is in the range from about 10 to about 2500 rad/min, and the electron beam dose rate is from about 10 to about 108 rads/min.

12. The method of claim 1 including the step of incorporating in said polymerized coating a drug.

13. The method of claim 12 wherein said drug is an anti-microbial agent.

14. The method of claim 12 wherein said drug is a therapeutic agent.

15. A composition of matter prepared by the method of claim 1.

16. An article of manufacture comprising the composition of matter of claim 15.

17. The article of manufacture of claim 16 comprising an intraocular lens, ocular implant, catheter, pacer lead, surgical tubing, endotracheal tube, blood bag, peripheral nerve graft, contact lens, dialysis shunt, breast implant, soft tissue implant for plastic surgery, myringotomy tubing, glaucoma shunt, surface interface device for neural connections, hernia repair membrane or bio-DNA chip.
